(19) United States
(12) Patent Application Publication
(10) Pub. No.: US 2020/0049589 A1
(43) Pub. Date: Feb. 13, 2020

(54) METHOD AND DEVICE FOR EVALUATING SERVICE LIFE OF BEARING

(71) Applicant: SCHAEFFLER TECHNOLOGIES AG & CO. KG, HERZOGENAURACH (DE)

(72) Inventors: Gilson ARIMA, Shanghai (CN); Zikui MA, Shanghai (CN); Lei GUO, Shanghai (CN); Lai WEI, Shanghai (CN); Hualiang HU, Shanghai (CN); Yunsheng HUANG, Kunshan (CN)

(73) Assignee: SCHAEFFLER TECHNOLOGIES AG & CO. KG, HERZOGENAURACH (DE)

(21) Appl. No.: 16/342,348

(22) PCT Filed: Nov. 1, 2017
(86) PCT No.: PCT/CN2017/108878

§ 371 Date: Apr. 16, 2019

(30) Foreign Application Priority Data
Dec. 1, 2016 (CN) 201611095596.3

(51) Int. Cl. G01M 13/045; F16C 19/52

(52) U.S. Cl. CPC G01M 13/045; F16C 19/525; F16C 19/527; F16C 19/522

(57) ABSTRACT

A device for evaluating the service life of a bearing includes an operating condition obtainment unit configured to obtain a current operating condition of the bearing, a first acquisition unit configured to acquire a current vibration signal of the bearing under the current operating condition, a computation unit configured to compute a current vibration value of the bearing, a spalling obtainment unit configured to obtain a current surface spalling area of the bearing corresponding to the current vibration value of the bearing and further configured to obtain a current spalling rate of the bearing under the current operating condition, and a replacement reminder unit configured to transmit a bearing replacement reminder information when the current surface spalling area of the bearing is detected to be greater than a predetermined first area.

### CROSS-REFERENCE TO RELATED APPLICATIONS

This application is the U.S. National Phase of PCT/CN2017/108878 filed Nov. 1, 2017, which claims priority to CN 201611095596.3 filed Dec. 1, 2016, the entire disclosures of which are incorporated by reference herein.

### TECHNICAL FIELD

The present disclosure relates to the field of bearings and a method and device for evaluating bearing service life.

### BACKGROUND

Bearings are basic components of mechanical equipment, and the degree of precision and service life of bearings are of vital importance to the normal operation of mechanical equipment.

The service life of a rolling bearing is briefly divided into the following two stages based on its degree of fatigue: service life before spalling of the bearing's working surface occurs and service life after spalling of the bearing's working surface. The process from the start of spalling of the bearing's working surface to the severe spalling thereof warranting a judgment of failure is the residual service life of the bearing after spalling of the bearing's working surface takes place. In comparison with the service life of the bearing before spalling of its working surface takes place, the service life thereof after spalling of its working surface occurs is shorter.

In the prior art, bearings are overhauled during overhaul outages at a certain time interval to ensure the normal operation of mechanical equipment. For some complex systems, overhaul outage would affect the normal operation of equipment and cause significant cost expiration.

### SUMMARY

The technical problem to be resolved by the present disclosure lies in how impact on the normal operation of equipment can be prevented during the process of bearing service life evaluation.

To this end, an embodiment of the present disclosure provides a method for evaluating bearing service life which comprises: obtaining a current operating condition of the bearing; acquiring a current vibration signal of the bearing under the current operating condition, and computing a current vibration value of the bearing; obtaining a current surface spalling area of the bearing corresponding to the current vibration value of the bearing, and a current spalling rate of the bearing under the current operating condition; and obtaining the residual service life of the bearing based on the current surface spalling area of the bearing and the current spalling rate of the bearing.

Alternatively, the method for evaluating bearing service life further comprises: obtaining a current temperature information of the bearing; wherein the step of obtaining the residual service life of the bearing based on the current surface spalling area of the bearing and the current spalling rate of the bearing comprises: obtaining the residual service life of the bearing based on the current surface spalling area of the bearing, the current spalling rate of the bearing and the current temperature information of the bearing.

Alternatively, the method for evaluating bearing service life further comprises: obtaining a current rotational speed information of the bearing; wherein the step of obtaining the residual service life of the bearing based on the current surface spalling area of the bearing and the current spalling rate of the bearing comprises: obtaining the residual service life of the bearing based on the current surface spalling area of the bearing, the current spalling rate of the bearing and the current rotational speed information of the bearing.

Alternatively, the method for evaluating bearing service life further comprises: obtaining a current temperature information of the bearing and a current rotational speed information of the bearing; wherein the step of obtaining the residual service life of the bearing based on the current surface spalling area of the bearing and the current spalling rate of the bearing comprises: obtaining the residual service life of the bearing based on the current temperature information of the bearing, the current rotational speed information of the bearing, the current surface spalling area of the bearing and the current spalling rate of the bearing.

Alternatively, the step of obtaining a current surface spalling area of the bearing corresponding to the current vibration value of the bearing comprises: computing a current vibration level of the bearing based on the current vibration value of the bearing; and obtaining a current surface spalling area of the bearing corresponding to the current vibration level of the bearing.

Alternatively, the method further comprises the following step after the step of obtaining a current surface spalling area of the bearing: transmitting a bearing replacement reminder information when it is detected that the current surface spalling area of the bearing is greater than a predetermined first area.

Alternatively, the method further comprises the following step after the step of transmitting a bearing replacement reminder information: transmitting a warning information when it is detected that the current surface spalling area of the bearing is greater than a predetermined second area; the second area is greater than the first area.

An embodiment of the present disclosure further provides a device for evaluating bearing service life which comprises: an operating condition obtainment unit configured to obtain a current operating condition of the bearing; a first acquisition unit configured to acquire a current vibration signal of the bearing under the current operating condition; a computation unit configured to compute a current vibration value of the bearing; a spalling area obtainment unit configured to obtain a current surface spalling area of the bearing corresponding to the current vibration value of the bearing; a spalling rate obtainment unit configured to obtain a current spalling rate of the bearing under the current operating condition; and a bearing service life obtainment unit configured to obtain the residual service life of the bearing based on the current surface spalling area of the bearing and the current spalling rate of the bearing.

Alternatively, the device for evaluating bearing service life further comprises: a second acquisition unit configured to acquire a current temperature information of the bearing; the bearing service life obtainment unit configured to obtain the residual service life of the bearing based on the current surface spalling area of the bearing, the current spalling rate of the bearing and the current temperature information of the bearing.

Alternatively, the device for evaluating bearing service life further comprises: a third acquisition unit configured to acquire a current rotational speed information of the bearing; the bearing service life obtainment unit configured to obtain the residual service life of the bearing based on the current surface spalling area of the bearing, the current spalling rate of the bearing and the current rotational speed information of the bearing.

Alternatively, the device for evaluating bearing service life further comprises: a fourth acquisition unit configured to acquire a current temperature information of the bearing and a current rotational speed information of the bearing; the bearing service life obtainment unit configured to obtain the residual service life of the bearing based on the current temperature information of the bearing, the current rotational speed information of the bearing, the current surface spalling area of the bearing and the current spalling rate of the bearing.

Alternatively, the spalling area obtainment unit is configured to compute a current vibration level of the bearing; and to obtain a current surface spalling area of the bearing corresponding to the current vibration level of the bearing.

Alternatively, the device for evaluating bearing service life further comprises: a replacement reminder information transmission unit configured to transmit a bearing replacement reminder information when it is detected that the current surface spalling area of the bearing is greater than the predetermined first area.

Alternatively, the device for evaluating bearing service life further comprises: a warning information transmission unit configured to transmit a warning information when it is detected that the current surface spalling area of the bearing is greater than the predetermined second area; the second area is greater than the first area.

In comparison with the prior art, the technical solution provided by the embodiment of the present disclosure has the following beneficial effects:

A current vibration value of the bearing can be known after acquiring a vibration signal of the bearing. A corresponding current surface spalling area of the bearing can be obtained based on the current vibration value of the bearing. The residual service life of the bearing can be known based on the current surface spalling area of the bearing and the current spalling rate of the bearing under the current operating condition, without affecting the normal operation of mechanical equipment.

Further, obtaining the residual service life of the bearing by acquiring a current temperature information of the bearing and evaluating the residual service life of the bearing based on the impact of the current temperature of the bearing on the service life of the bearing help to improve the accuracy of evaluation.

Further, obtaining the residual service life of the bearing by acquiring a current rotational speed information of the bearing and evaluating the residual service life of the bearing based on the impact of the current rotational speed of the bearing on the service life of the bearing help to improve the accuracy of evaluation.

Further, transmitting a bearing replacement reminder information when the current surface spalling area of the bearing is detected to be greater than a predetermined first area serves to remind workers to replace the bearing.

In addition, transmitting a warning information when the current surface spalling area of the bearing is detected to be greater than a predetermined second area serves to remind workers of the severe damage to the bearing, thereby improving equipment and work safety.

### BRIEF DESCRIPTION OF THE DRAWINGS

FIG. 1 is a flowchart illustrating a method for evaluating bearing service life in an embodiment of the present disclosure.

FIG. 2 is a graph illustrating the correlation between the vibration level of a bearing and the surface spalling area of the bearing in an embodiment of the present disclosure.

FIG. 3 is a graph illustrating the correlation between the surface spalling area and spalling rate of a bearing and the residual service life of the bearing in an embodiment of the present disclosure.

FIG. 4 is a structural schematic of a device for evaluating bearing service life in an embodiment of the present disclosure.

### DETAILED DESCRIPTION

In the prior art, bearings are overhauled during overhaul outages at a certain time interval to ensure the normal operation of mechanical equipment. Or, bearings are replaced when it is detected that severe vibration or severe heating of bearings occurs.

However, for some complex systems, overhaul outage would affect the normal operation of equipment and cause significant cost expiration.

In an embodiment of the present disclosure, a current vibration value of the bearing can be known after acquiring a vibration signal of the bearing. A corresponding current surface spalling area of the bearing can be obtained based on the current vibration value of the bearing. The residual service life of the bearing can be known based on the current surface spalling area of the bearing and the current spalling rate of the bearing under the current operating condition, without affecting the normal operation of mechanical equipment.

For better understanding of the aforementioned objectives, features and beneficial effects of the present disclosure, specific embodiments thereof are described below in further detail with reference to the accompanying drawings.

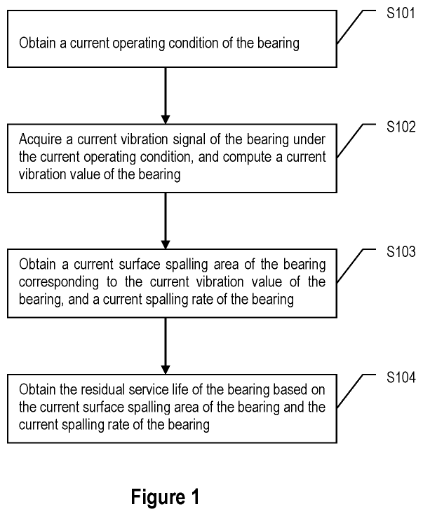

As shown in FIG. 1, the present disclosure provides a method for evaluating bearing service life, the steps of which are described below in detail.

Step S101: obtaining a current operating condition of the bearing.

In a particular embodiment, parameter information of a bearing can be acquired realtimely to obtain a current operating condition corresponding to the bearing. For example, information associated with the bearing, such as the rotational speed thereof, the load thereof and the ambient temperature thereof, is acquired realtimely to obtain current operating conditions of the bearing.

Step S102: acquiring a current vibration signal of the bearing under the current operating condition, and computing a current vibration value of the bearing.

In a particular embodiment, a vibration signal of a bearing can be acquired realtimely during the operation process of the bearing.

Step S103: obtaining a current surface spalling area of the bearing corresponding to the current vibration value of the bearing, and a current spalling rate of the bearing under the current operating condition;

In a particular embodiment, mapping relation between a vibration value of a bearing and a surface spalling area of the bearing can be preset. After determining a current vibration value of the bearing through computation, a corresponding surface spalling area of the bearing can be obtained by looking up table.

In actual application, a number of experiments may first be performed on bearings of the same model with different surface spalling areas under various operating conditions. Mapping relations between the vibration values of the bearings and the surface spalling areas of the bearings can be established based on the parameters obtained from the experiments.

It can be known from actual application that even for bearings with a surface spalling area of zero (0), i.e. bearings with intact surfaces, a certain extent of vibration is generated during their operation. Under different operating conditions, the rotational speed of a bearing may vary and the vibration value of the bearing when the surface spalling area thereof is zero (0) may also be different due to different loads.

In an embodiment of the present disclosure, to eliminate the impacts of load variation and rotational speed variation on the vibration value of a bearing, a current vibration value of the bearing may be quantified to obtain a current vibration level of the bearing. A mapping relation with the corresponding surface spalling area of the bearing is then established based on the vibration level of the bearing. The vibration level of the bearing and the load thereof are not related to the rotational speed thereof, therefore it is not necessary to take into account any impacts of load variation and rotational speed variation on the vibration value of the bearing in the mapping relation between the vibration level of the bearing and the corresponding surface spalling area thereof.

In a particular embodiment, after obtaining a current vibration value of a bearing the current vibration value thereof is quantified to obtain a current vibration level corresponding to the current vibration value of the bearing. After obtaining the current vibration level of the bearing, a current surface spalling area of the bearing can be found.

In an embodiment of the present disclosure, after obtaining a current vibration value of the bearing, the current vibration value is then divided by the vibration value when the surface spalling area of the bearing is zero (0) under the same conditions, and the ratio obtained is taken as the current vibration level of the bearing.

The establishment of mapping relation between the vibration level of a bearing and the surface spalling area thereof in an embodiment of the present disclosure is further described below.

Under normal operating conditions, a primary failure mode of bearings is fatigue spalling. Under normal circumstances, bearing fatigue life is computed as the service life of a bearing before spalling occurs to the surface of the bearing. According to the maximum dynamic shear stress theory, bearing spalling begins at the materials weak points in the area beneath the subsurface subjected to the maximum shear stress parallel to the direction of rotation, and gradually extends to the surface of the bearing. The depth of bearing surface spalling is usually within a certain extent, and the surface spalling area thereof gradually increases along with the increase in the degree of fatigue, and the extent of bearing vibration would also show a certain pattern.

In a particular embodiment, experiments may first be performed on a certain bearing to build a model and the correlation between the surface spalling areas of the bearing and the vibration levels thereof is found. For the built model to be more universal, experiments may be performed on the bearing in different scenarios under various operating conditions.

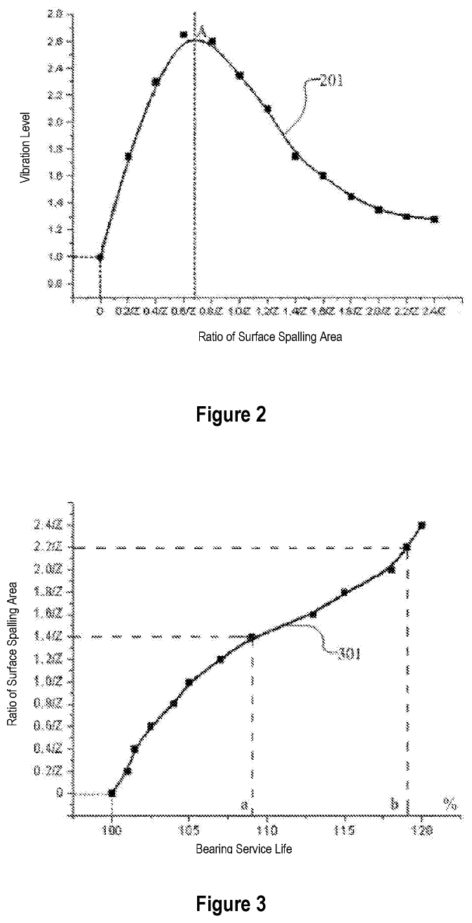

Multiple experiments are performed on bearings of the same model under various operating conditions, and the correlation between the surface spalling areas of the bearings and the vibration levels thereof is obtained. FIG. 2 is a graph illustrating the correlation between the vibration level of a bearing and the surface spalling area of the bearing in an embodiment of the present disclosure. In FIG. 2, the horizontal axis represents the ratio of the bearing surface spalling area to the raceway total effective area and the vertical axis represents the vibration level of the bearing. A vibration level of a bearing refers to the ratio between the vibration value of the bearing obtained by measurement and the vibration value of the bearing when bearing surface spalling is not present under the same circumstances. It is assumed that when the vibration level is one (1) bearing surface spalling is not present, i.e. the bearing surface spalling area is zero (0).

It can be seen from FIG. 2 that under a certain loading condition, the surface spalling area of a single raceway (inner circle or outer circle) is within a certain extent, and the bearing vibration level curve 201 first gradually ascends and begins to gradually descend after reaching the extremum point A. The function expression of bearing vibration levels may be defined as:

V_{RMS}=f(nᵢ, x) (1)

where 0<x<2/Z, Z is the number of bearing rollers, nᵢ is the bearing's inner circle rotational speed, x is the ratio of defective area of a single raceway to the raceway total effective area. Before the bearing surface spalling area reaches 1/Z of the raceway total effective area, the bearing vibration level reaches the extremum point A.

From the perspective of practical physics, the factors contributing to the non-linear variation of vibration level are multifaceted. It is assumed that bearing surface spalling occurs in the bearing area and that the depth of spalling remains constant. Along with the increase in spalling area, the rollers change from being loaded to being unloaded when they roll across the spalling area and the entire bearing area of the bearing undergoes changes. Therefore, when no surface spalling occurs to the bearing, the vibration value of the bearing is relatively smaller. When surface spalling of the bearing begins, the vibration level of the bearing increases; and when the bearing surface spalling area reaches a certain value, the vibration level thereof decreases gradually.

It can be known from actual application that different bearings under different operating conditions have different surface spalling rates after spalling occurs to their surfaces. Therefore, multiple experiments may first be performed on the spalling rates corresponding respectively to different surface spalling areas of bearings of the same model under different operating conditions. The corresponding bearing spalling rates under different operating conditions may be established based on the parameters obtained from the multiple experiments.

Therefore, in an embodiment of the present disclosure, after obtaining a current surface spalling area of the bearing, a current spalling rate of the bearing corresponding to the current operating condition of the bearing may be found based on the current operating condition of the bearing.

Step S104: obtaining the residual service life of the bearing based on the current surface spalling area of the bearing and the current spalling rate of the bearing.

In an embodiment of the present disclosure, a mapping relation between the surface spalling area and spalling rate of a bearing and the residual service life thereof may first be established. For example, a mapping relation between the surface spalling area and spalling rate of a bearing and the residual service life thereof is established in the form of a mapping table. Thereafter, the residual service life the bearing can be obtained after obtaining the current surface spalling area of the bearing and the current spalling rate thereof.

In actual application, a mapping relation between the surface spalling area and spalling rate of the bearing and the residual service life thereof may be established based on the parameters obtained from multiple experiments.

FIG. 3 is a graph illustrating the correlation between the surface spalling area and spalling rate of a bearing and the residual service life of the bearing in an embodiment of the present disclosure. In FIG. 3, the vertical axis represents the ratio of the surface spalling area of a bearing to the raceway total effective area, and the horizontal axis represents the percentage of the residual service life of the bearing in relation to the service life of the bearing before spalling occurs to its working surface, i.e. 100% indicates that the service life of the bearing at the time equals to the service life of the bearing before spalling occurs to its working surface; the curve 301 represents the spalling rates of the bearing.

It is assumed that when the surface spalling area of the bearing constitutes 2.2/Z of the raceway total effective area, the residual service life of the bearing after surface spalling occurs to the bearing ends. Then, upon obtaining that the current surface spalling area of the bearing to be 1.4/Z of the raceway total effective area and after obtaining the current spalling rate of the bearing, the residual service life of the bearing is known to be (b−a)×t, where t is service life of the bearing before spalling occurs to its working service, while (b−a) is the percentage of the residual service life of the bearing in relation to the service life of the bearing before spalling occurs to its working service.

It can therefore be seen that a current vibration value of the bearing can be known after acquiring a vibration signal of the bearing. A corresponding current surface spalling area of the bearing can be obtained based on the current vibration value of the bearing. The residual service life of the bearing can be known based on the current surface spalling area of the bearing and the current spalling rate of the bearing under the current operating condition, without affecting the normal operation of mechanical equipment.

It can be known from actual application that the rotational speed of a bearing will have some impact on the service life of the bearing and the temperature of the bearing will also have some impact on the service life thereof.

When establishing a mapping relation between the surface spalling area and spalling rate of a bearing and the residual service life of the bearing, temperature information of the bearing may be added, i.e. in the established mapping relation, the residual service life of the bearing is related to the surface spalling area, the spalling rate and the temperature of the bearing.

Obtaining the residual service life of a bearing based on the current operating condition of the bearing, the current surface spalling area thereof, the current spalling rate thereof and the current temperature thereof may help to improve the degree of precision of the obtained residual service life thereof.

Accordingly, when establishing a mapping relation between the surface spalling area and spalling rate of a bearing and the residual service life of the bearing, rotational speed information of the bearing may also be added, i.e. in the established mapping relation, the residual service life of the bearing is related to the surface spalling area, the spalling rate and the rotational speed of the bearing.

Obtaining the residual service life of a bearing based on the current operating condition of the bearing, the current surface spalling area thereof, the current spalling rate thereof and the current rotational speed thereof may help to improve the degree of precision of the obtained residual service life thereof.

When establishing a mapping relation between the surface spalling area and spalling rate of a bearing and the residual service life of the bearing, temperature information of the bearing and rotational speed information thereof may also be added, i.e. in the established mapping relation, the residual service life of the bearing is related to the surface spalling area, the spalling rate, the temperature and the rotational speed of the bearing.

Obtaining the residual service life of a bearing based on the current operating condition of the bearing, the current surface spalling area thereof, the current spalling rate thereof, the current temperature information thereof and the current rotational speed thereof may help to improve the degree of precision of the obtained residual service life thereof.

In an embodiment of the present disclosure, when it is detected at some point that the current surface spalling area of the bearing is greater than the predetermined first area, it can be judged that the bearing is damaged. If the complex mechanical system continues operating, an abnormal operation thereof may be caused. At this time, a bearing replacement reminder information may be generated and transmitted to remind operators to have the bearing in the mechanical system replaced.

For example, the generated bearing replacement reminder information may be transmitted to a status monitoring device of the mechanical system, such as displaying “Replace bearings” on the monitor of the status monitoring device. Upon seeing “Replace bearings” on the monitor of the status monitoring device, operators may make arrangements to have the bearings replaced.

It can be known from the above embodiments of the present disclosure that after surface spalling occurs to the bearing, the surface spalling area of the bearing gradually increases along with the increase in the operating time of the bearing. When the surface spalling area of the bearing increases to a certain extent, it may cause the mechanical equipment to be unable to operate normally or even result in accidents if the mechanical system continues operating.

In a particular embodiment, when it is detected at some point that the current surface spalling area of the bearing is greater than the predetermined second area, a warning information may be generated and transmitted to remind operators to have the bearings replaced immediately so as to prevent accidents.

In an embodiment of the present disclosure, a first area and a second area may be set according to the actual application scenarios with the first area smaller than the second area. In other words, when the surface spalling area of a bearing is relatively small, operators may be reminded to have the bearing replaced. When the surface spalling area of the bearing is relatively large, operators are reminded to have the bearing replaced as fast as possible in order to prevent accidents.

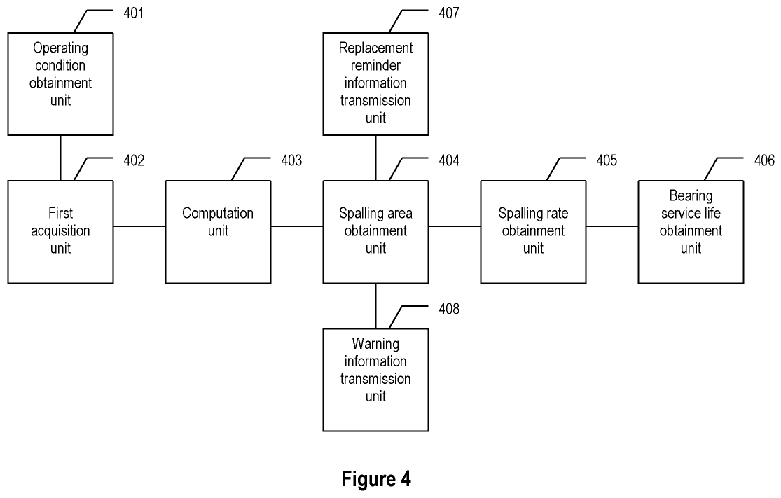

FIG. 4 illustrates an embodiment of the present disclosure providing a device for evaluating bearing service life. The device for evaluating bearing service life comprises: an operating condition obtainment unit 401, a first acquisition unit 402, a computation unit 403, a spalling area obtainment unit 404, a spalling rate obtainment unit 405, and a bearing service life obtainment unit 406, wherein:

The operating condition obtainment unit 401 is configured to obtain a current operating condition of the bearing;

The first acquisition unit 402 is configured to acquire a current vibration signal of the bearing under the current operating condition;

The computation unit 403 is configured to compute a current vibration value of the bearing;

The spalling area obtainment unit 404 is configured to obtain a current surface spalling area of the bearing corresponding to the current vibration value of the bearing;

The spalling rate obtainment unit 405 is configured to obtain a current spalling rate of the bearing under the current operating condition; and

The bearing service life obtainment unit 406 is configured to obtain the residual service life of the bearing based on the current surface spalling area of the bearing and the current spalling rate of the bearing.

In a particular embodiment, the device for evaluating bearing service life may further comprise: a second acquisition unit (not shown) configured to acquire a current temperature information of the bearing; the bearing service life obtainment unit 406 which may be configured to obtain the residual service life of the bearing based on the current surface spalling area of the bearing, the current spalling rate of the bearing and the current temperature information of the bearing.

In a particular embodiment, the device for evaluating bearing service life may further comprise: a third acquisition unit (not shown in FIG. 4) configured to acquire a current rotational speed information of the bearing; the bearing service life obtainment unit 406 which may be configured to obtain the residual service life of the bearing based on the current surface spalling area of the bearing, the current spalling rate of the bearing and the current rotational speed information of the bearing.

In a particular embodiment, the device for evaluating bearing service life may further comprise: a fourth acquisition unit (not shown in FIG. 4) configured to acquire a current temperature information of the bearing and a current rotational speed information of the bearing; the bearing service life obtainment unit 406 which may be configured to obtain the residual service life of the bearing based on the current temperature information of the bearing, the current rotational speed information of the bearing, the current surface spalling area of the bearing and the current spalling rate of the bearing.

In a particular embodiment, the spalling area obtainment unit 404 is configured to compute a current vibration level of the bearing; and to obtain a current surface spalling area of the bearing corresponding to the current vibration level of the bearing.

In a particular embodiment, the device for evaluating bearing service life may further comprise: a replacement reminder information transmission unit 407 configured to transmit a bearing replacement reminder information when it is detected that the current surface spalling area of the bearing is greater than the predetermined first area.

In a particular embodiment, the device for evaluating bearing service life may further comprise: a warning information transmission unit 408 configured to transmit a warning information when it is detected that the current surface spalling area of the bearing is greater than the predetermined second area; the second area is greater than the first area.

It is understood by persons of ordinary skill in the art that all or some of the various methods of the foregoing embodiments may be accomplished using hardware instructed by a program capable of being stored in a computer readable storage medium, including a read-only memory (ROM), a random access memory (RAM), a magnetic disk or a compact disk.

While the foregoing illustrates preferred embodiments of the present disclosure, the present disclosure is not limited thereby, and persons skilled in the art will be able to make various alterations and modifications without departing from the spirit of the present disclosure. Hence the scope of protection of the present disclosure shall be defined by the appended claims.

1. A method for evaluating service life of a bearing, comprising:
obtaining a current operating condition of the bearing;
acquiring a current vibration signal of the bearing under the current operating condition and computing a current vibration value of the bearing;
obtaining a current surface spalling area of the bearing corresponding to the current vibration value, and a current spalling rate of the bearing under the current operating condition; and
obtaining a residual service life of the bearing in response to the current surface spalling area of the bearing and the current spalling rate of the bearing.

2. The method of claim 1, further comprising:
obtaining a current temperature information of the bearing;
wherein the step of obtaining the residual service life of the bearing based on the current surface spalling area of the bearing and the current spalling rate of the bearing further includes obtaining the residual service life of the bearing based on the current surface spalling area of the bearing, the current spalling rate of the bearing, and the current temperature information of the bearing.

3. The method of claim 1, further comprising:
obtaining a current rotational speed information of the bearing;
wherein the step of obtaining the residual service life of the bearing based on the current surface spalling area of the bearing and the current spalling rate of the bearing further includes obtaining the residual service life of the bearing based on the current surface spalling area of the bearing, the current spalling rate of the bearing and the current rotational speed information of the bearing.

4. The method of claim 1, further comprising:
obtaining a current temperature information of the bearing and a current rotational speed information of the bearing; and
wherein the step of obtaining the residual service life of the bearing based on the current surface spalling area of the bearing and the current spalling rate of the bearing comprises:
obtaining the residual service life of the bearing based on the current temperature information of the bearing, the current rotational speed information of the bearing, the current surface spalling area of the bearing and the current spalling rate of the bearing.

5. The method of claim 1, wherein the step of obtaining a current surface spalling area of the bearing corresponding to the current vibration value of the bearing comprises:
computing a current vibration level of the bearing based on the current vibration value of the bearing; and
obtaining a current surface spalling area of the bearing corresponding to the current vibration level of the bearing.

6. The method of claim 1, wherein the method further includes
transmitting a bearing replacement reminder information when it is detected that the current surface spalling area of the bearing is greater than a predetermined first area.

7. The method of claim 6, wherein the method further includes
transmitting a warning information when it is detected that the current surface spalling area of the bearing is greater than a predetermined second area, wherein the second area is greater than the first area.

8. A device for evaluating a service life of a bearing, comprising:
an operating condition obtainment unit configured to obtain a current operating condition of the bearing;
a first acquisition unit configured to acquire a current vibration signal of the bearing under the current operating condition;
a computation unit configured to compute a current vibration value of the bearing;
a spalling area obtainment unit configured to obtain a current surface spalling area of the bearing corresponding to the current vibration value of the bearing;
a spalling rate obtainment unit configured to obtain a current spalling rate of the bearing under the current operating condition; and
a bearing service life obtainment unit configured to obtain a residual service life of the bearing in response to the current surface spalling area of the bearing and the current spalling rate of the bearing.

9. The device of in claim 8, further comprising:
a second acquisition unit configured to acquire a current temperature information of the bearing; and
wherein the bearing service life obtainment unit configured to obtain the residual service life of the bearing based on the current surface spalling area of the bearing, the current spalling rate of the bearing and the current temperature information of the bearing.

10. The device of claim 8, further comprising:
a third acquisition unit configured to acquire a current rotational speed information of the bearing; and
the bearing service life obtainment unit configured to obtain the residual service life of the bearing based on the current surface spalling area of the bearing, the current spalling rate of the bearing and the current rotational speed information of the bearing.

11. The device of claim 8, further comprising:
a fourth acquisition unit configured to acquire a current temperature information of the bearing and a current rotational speed information of the bearing; and
the bearing service life obtainment unit configured to obtain the residual service life of the bearing based on the current temperature information of the bearing, the current rotational speed information of the bearing, the current surface spalling area of the bearing and the current spalling rate of the bearing.

12. The device of claim 8, wherein the spalling area obtainment unit is configured to compute a current vibration level of the bearing; and to obtain a current surface spalling area of the bearing corresponding to the current vibration level of the bearing.

13. The device of claim 8, further comprising:
a replacement reminder information transmission unit configured to transmit a bearing replacement reminder information when it is detected that the current surface spalling area of the bearing is greater than a predetermined first area.

14. The device of claim 13, further comprising:
a warning information transmission unit configured to transmit a warning information when it is detected that the current surface spalling area of the bearing is greater than the predetermined second area; the second area is greater than the first area.

15. A device for evaluating the service life of a bearing, comprising:
an operating condition obtainment unit configured to obtain a current operating condition of the bearing;
a first acquisition unit configured to acquire a current vibration signal of the bearing under the current operating condition;
a computation unit configured to compute a current vibration value of the bearing;
a spalling obtainment unit configured to obtain a current surface spalling area of the bearing corresponding to the current vibration value of the bearing and further configured to obtain a current spalling rate of the bearing under the current operating condition; and
a replacement reminder unit configured to transmit a bearing replacement reminder information when the current surface spalling area of the bearing is detected to be greater than a predetermined first area.

16. The device of claim 15, wherein the device includes a second acquisition unit configured to acquire a current temperature information of the bearing.

17. The device of claim 15, wherein the replacement reminder unit is configured to transmit the bearing replacement reminder informatic to a status monitoring device.

18. The device of claim 15, wherein the device includes a bearing service life obtainment unit configured to obtain a residual service life of the bearing based on the current surface spalling area of the bearing and the current spalling rate of the bearing.

19. The device of claim 18, wherein the bearing service life obtainment unit is further configured to obtain the residual service life of the bearing based on the current temperature information of the bearing.

20. The device of claim 15, wherein the device includes a warning information transmission unit configured to transmit warning information in response to detecting the current surface spalling area of the bearing being greater than a predetermined second area.
